(19) United States
(12) Patent Application Publication
(10) Pub. No.: US 2005/0101339 A1
(43) Pub. Date: May 12, 2005

(54) Method and apparatus for recursive audio storage in a communication system

(76) Inventors: Craig G. Bishop, Boca Raton, FL (US); Kevin M. Eldred, Sunrise, FL (US); Timothy W. Heffield, Sunrise, FL (US)

Correspondence Address: AKERMAN SENTERFITT, P.O. BOX 3188, WEST PALM BEACH, FL, 33402-3188, US

(21) Appl. No.: 10/703,252

(22) Filed: Nov. 7, 2003

(51) Int. Cl. H04B 7/00

(52) U.S. Cl. 455/521; 455/517

(57) ABSTRACT

A communication system (50) can include a first portable communication unit (72) operating in a dispatch mode with at least a second portable communication unit (78) and an infrastructure system (50A and 50B) providing a communication link between the first and second portable communication units. The infrastructure system can include a memory (61,63) for recursively storing a most recent audio stream from at least one among the first or second portable communication unit. The infrastructure system can further include a dispatch application processor (62). The communication system can further include a means for retrieving a most recent dispatch signal stored at the infrastructure system upon determining a received signal quality level below a predetermined threshold at the second portable communication unit or upon a user request of at least one the portable communication units.

### CROSS-REFERENCE TO RELATED APPLICATIONS

Not applicable

### FIELD OF THE INVENTION

This invention relates generally to audio storage, and more particularly to a system and method for recursively storing audio in one or more among a portable communication radio, a base station or a communication switch for subsequent retrieval.

### BACKGROUND OF THE INVENTION

Telecommunication systems are subject to interference and other anomalies that corrupt audio being sent to or received by the user. In half-duplex communication (i.e. dispatch), there is no feedback if the audio is garbled, missed, or corrupted. Thus, vital information can be missed without having any means of effectively retrieving or re-creating information that has been sent.

Existing cellular phones, dispatch radios, and other telecommunication devices contain ample amounts of memory that can be utilized to store digital or analog audio. Additionally, the base station is capable of storing virtually unlimited amounts of sampled audio. There are numerous devices that store voice in a subscriber unit as discussed in U.S. Pat. No. 6,580,903 by Hein et al. For example, there are several paging devices and cellular phones that store voice (see U.S. Pat. No. 5,455,579 by Bennett et al). There are also dispatch radio systems that provide voice mail service as discussed in U.S. Pat. No. 5,711,011 by Urs et al. None of these existing systems store voice for the purpose of retrieving real-time or near real-time voice or data.

### SUMMARY OF THE INVENTION

A method and apparatus for recursively storing audio in a communication system can resolve or alleviate many of the issues experienced by dispatched radio users when subject to interference and other anomalies that corrupt the audio.

In one embodiment of the present invention, a method of recursively storing audio in a communication system can comprise the steps of recursively storing audio in at least one among a transmitting subscriber unit, a receiving subscriber unit, and a communication switch in remote communication with the transmitting subscriber unit and selectively retrieving audio previously transmitted by the transmitting subscriber unit. The stored audio can be retrieved at the request of the receiving or transmitting subscriber unit from at least one among the receiving or transmitting subscriber unit and the communication switch. The audio signal can be a dispatch radio signal that can be stored at a dispatch application processor forming part of the communication switch. The step of retrieving can include the step of retrieving a most recent dispatch signal stored at the communication switch upon a user request of the receiving subscriber unit or upon determining a received signal quality level below a predetermined threshold at the receiving subscriber unit.

In a second aspect of the present invention, a communication system can include a first portable communication unit operating in a dispatch mode with at least a second portable communication unit and an infrastructure system providing a communication link between the first portable communication unit and at least the second portable communication unit. The infrastructure system can include a memory for recursively storing a most recent audio stream from at least one among the first portable communication unit and at least the second portable communication unit. The infrastructure system can further include a dispatch application processor. The communication system can further include a means for retrieving a most recent dispatch signal stored at the infrastructure system upon determining a received signal quality level below a predetermined threshold at the second portable communication unit or upon a user request of at least one among the first portable communication unit and the second portable communication unit. The memory can store audio indefinitely until a subsequent audio stream overwrites the stored audio. The memory can also be optimized by sampling and compressing the stored audio stream.

In a third aspect of the present invention, a portable communication device can include a transceiver operating as a dispatch radio and a processor coupled to the transceiver. The processor can be programmed to request a retransmission of a recently transmitted audio stream from a memory in an infrastructure system serving the portable communication device and to receive the retransmission of the recently transmitted audio stream. The processor can also be programmed to automatically request the retransmission upon determining a received signal quality level below a predetermined threshold or upon a user request.

### BRIEF DESCRIPTION OF THE DRAWINGS

FIG. 1 is a block diagram of a portable communication device using a recursive memory in accordance with the present invention.

FIG. 2 is a block diagram of a communication system using recursive audio storage in accordance with present invention.

FIG. 3 illustrates dispatch communication between two portable communication devices in accordance with the present invention.

FIG. 4 is a flow chart illustrating a method of recursively storing audio in a communication system in accordance with the present invention.

### DETAILED DESCRIPTION OF THE DRAWINGS

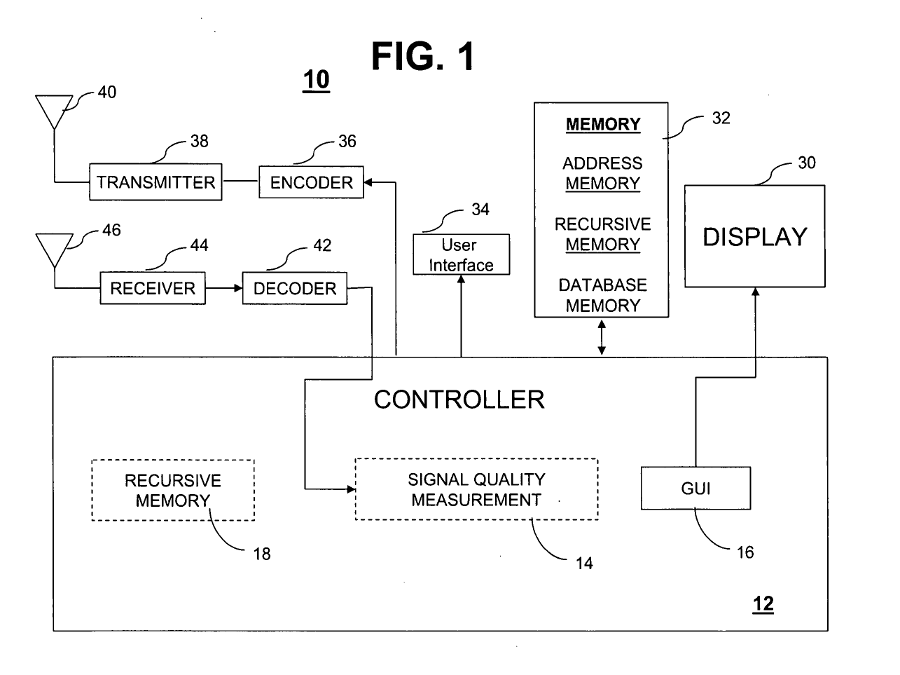

Referring to FIG. 1, a block diagram of a portable communication device 10 is shown. The device 10 can comprise, for example, a conventional cellular phone, a two-way trunked radio, a combination cellular phone and personal digital assistant, a smart phone, a home cordless phone, a satellite phone, a Motorola iDEN phone, or any device having sufficient memory for recursively storing audio in accordance with the present invention. Although the examples provided are directed towards a communication device able to operate in a dispatch voice mode, other modes such as an interconnect voice mode, peer-to-peer data mode, a peer-to-peer voice mode, or different protocol modes such as CDMA, TDMA, GSM, WLAN can also benefit from the concepts presented and claimed herein. In this particular embodiment, the portable communication device can include an encoder 36, transmitter 38 and antenna 40 for encoding and transmitting information as well as an antenna 46, receiver 44 and decoder 42 for receiving and decoding information sent to the portable communication device. The receiver 44 and transmitter 38 would comprise a transceiver. The device 10 can further include a user interface 34, a memory 32 and a display 30. The display can be coupled to a graphical user interface program or driver 16. The device 10 can further include a processor or controller 12 coupled to the display 30, the encoder 36, the decoder 42, the user interface 34. The memory 32 can include address memory, message memory, memory for keys and memory for database information. The memory 32 can also include recursive memory reserved for keeping a predetermined amount of currently received or currently transmitted audio. Alternatively, a recursive memory 18 can form a portion of and be integrated with the controller 12. Additionally, the device 10 can include a signal quality measurement 14 which can form a part of the controller 12. A predetermined threshold can be set to determine if a stored audio signal needs to be retransmitted. The signal quality measurement 14 can provide any measure of signal quality such as a received radio strength indication or bit error rate.

Operationally, embodiments in accordance with the invention can store sampled audio segments for replay upon user request or upon other predetermined events. A user's telecommunication device or another device in the communication link could recursively store streams of audio. Upon detection of an error, anomaly, or user request, the previous stream of audio could be replayed.

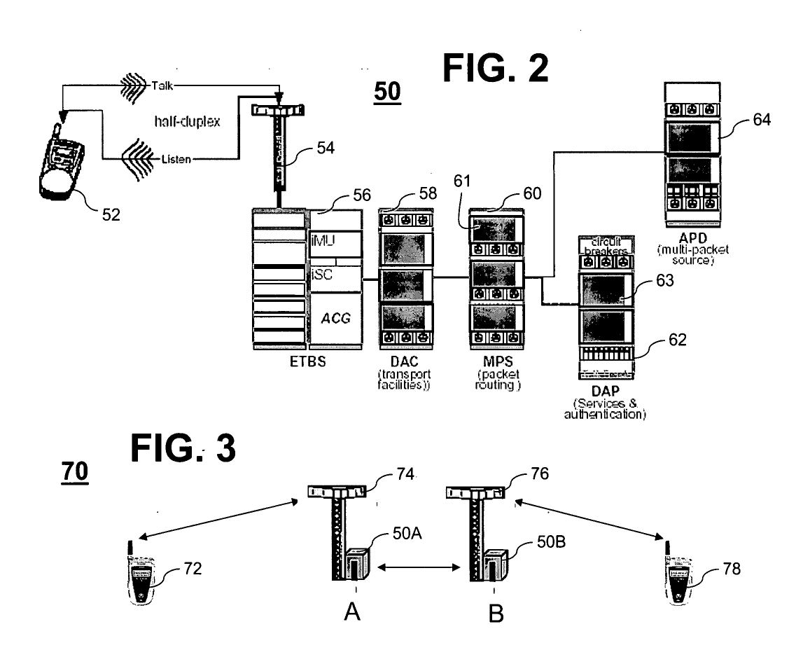

Referring to FIG. 2, a typical Motorola iDEN® communication system 50 is shown including a portable communication device 52, a communication tower or antenna 54, an enhanced transceiver base system (ETBS) 56, a digital access cross-connect (DAC) 58, a metro packet switch 60, a Dispatch Application Processor (DAP) 62 and a multi-packet data application (APD) 64. Of course, the system 50 can include other components (not shown) such as a base site controller (BSC), mobile switching center (MSC), and an Operations and Maintenance center (O&MC) that enables interconnect (or cellular) services and other administrative network operations.

Operationally, the portable communication device 52 in the form of a phone receives (and transmits) audio from communication system 50. This audio would be transmitted into the phone and stored recursively as determined by memory and phone settings. The received audio would be replayed upon user request or upon detecting a lack of a minimum quality level. The audio can be indefinitely accessible until the next audio stream overwrites it. Phone settings and available memory would determine the amount and quality of the stored audio. Additionally, sampling and compression techniques could be used to optimize this invention. The memory location for storing in the recursively stored audio can be maintained at the transmitting phone, the infrastructure system, or the receiving phone.

Referring once again to FIG. 2, the DAP 62 or switch 60 receives audio from a subscriber or other system. This audio can be stored recursively in the DAP 62 or switch 60 (at respective memories 61 and 63) as determined by memory, phone mode (dispatch or interconnect), and carrier configuration. Referring to FIG. 3, the DAP or switch of respective systems (50A or 50B) on either tower 74 or 76 (sender or receiver) could be used to store the audio stream. Again, the user of either portable communication device (72 or 78) could request playback of the audio through messages sent to the system (50A or 50B). Optionally, an algorithm on the system 50A or 50B could determine where the audio is stored and keep track of audio transfer when moving from cell to cell in typical wireless usage.

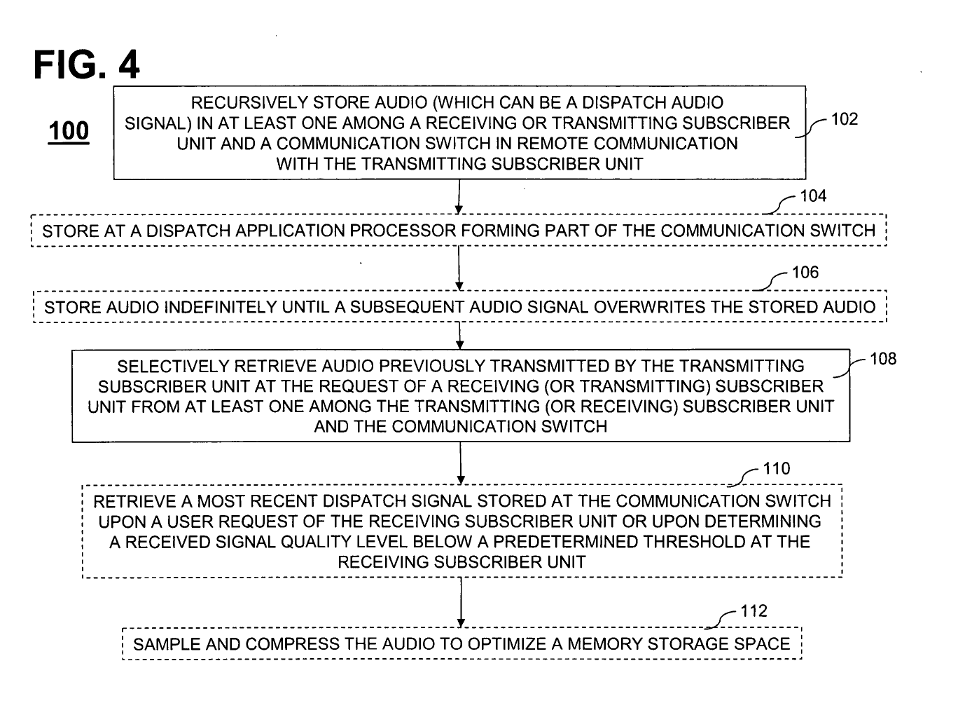

Referring to FIG. 4, a flow chart illustrating a method 100 of recursively storing audio in a communication system can comprise the step 102 of recursively storing audio in at least one among a transmitting subscriber unit, a receiving subscriber unit and a communication switch in remote communication with the transmitting subscriber unit (such as the DAP or MPS) and selectively retrieving audio previously transmitted by the transmitting subscriber unit at step 108. The step of retrieving can occur at the request of a receiving (or transmitting) subscriber unit from at least one among the transmitting (or receiving) subscriber unit and the communication switch. The audio signal can be a dispatch radio signal that can be stored at a dispatch application processor forming part of the communication switch as shown at optional step 104. The method 100 can optionally include the step 106 of storing audio indefinitely until a subsequent audio signal overwrites the stored audio. The step of retrieving can include the optional step 110 of retrieving a most recent dispatch signal stored at the communication switch upon a user request of the receiving or transmitting subscriber unit or upon determining a received signal quality level below a predetermined threshold at the receiving subscriber unit. The method 100 can further include the optional step 112 of sampling and compressing the audio to optimize the memory storage space utilized.

In light of the foregoing description, it should be recognized that embodiments in accordance with the present invention can be realized in hardware, software, or a combination of hardware and software. A method and system for secure communications in a communication device according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the methods described herein, is suited. A typical combination of hardware and software could be a general purpose computer system with a computer program that, when being loaded and executed, controls the computer system such that it carries out the methods described herein.

Additionally, the description above is intended by way of example only and is not intended to limit the present invention in any way, except as set forth in the following claims.

1. A method of recursively storing audio in a communication system, comprising the steps of:
recursively storing audio in at least one among a transmitting subscriber unit, a receiving subscriber unit, and a communication switch in remote communication with the transmitting subscriber unit; and
selectively retrieving audio previously transmitted by the transmitting subscriber unit.

2. The method of claim 1, wherein the step of retrieving audio previously transmitted by the transmitting subscriber unit comprises retrieving audio at the request of at least one among the receiving subscriber unit and the transmitting subscriber unit from at least one among the transmitting subscriber unit, receiving subscriber unit, and the communication switch.

3. The method of claim 1, wherein the step of recursively storing audio comprises the step of storing a most recent dispatch signal at the communication switch.

4. The method of claim 1, wherein the step of recursively storing audio comprises the step of storing a most recent dispatch signal at a dispatch application processor forming part of the communication switch.

5. The method of claim 1, wherein the step of selectively retrieving comprises the step of retrieving a most recent dispatch signal stored at the communication switch upon a user request of the receiving subscriber unit.

6. The method of claim 1, wherein the step of selectively retrieving comprises the step of retrieving a most recent dispatch signal stored at the communication switch upon determining a received signal quality level below a predetermined threshold at the receiving subscriber unit.

7. The method of claim 1, wherein the method of recursively storing audio comprises the step of step of storing a most recent signal of a predetermined length and overwriting the most recent signal with a subsequent signal of the predetermined length.

8. The method of claim 1, wherein the step of selectively retrieving comprises the step of retrieving a most recent dispatch signal stored at dispatch application processor forming a part of the communication switch upon at least one among a user request of the receiving subscriber unit and a determination that a received signal quality level fell below a predetermined threshold at the receiving subscriber unit.

9. The method of claim 1, wherein the step of recursively storing audio comprises the step of storing audio indefinitely until a subsequent audio signal overwrites the stored audio.

10. The method of claim 1, wherein the method further comprises the step of sampling and compressing the audio to optimize a memory storage space.

11. A communication system, comprising:
a first portable communication unit operating in a dispatch mode with at least a second portable communication unit; and
an infrastructure system providing a communication link between the first portable communication unit and at least the second portable communication unit, wherein the infrastructure system comprises a memory for recursively storing a most recent audio stream from at least one among the first portable communication unit and at least the second portable communication unit.

12. The communication system of claim 11, wherein the infrastructure system further comprises a dispatch application processor.

13. The communication system of claim 11, wherein the system further comprises a means for retrieving a most recent dispatch signal stored at the infrastructure system upon determining a received signal quality level below a predetermined threshold at the second portable communication unit.

14. The communication system of claim 11, wherein the system further comprises a means for retrieving a most recent dispatch signal stored at the infrastructure system upon a user request of at least one among the first portable communication unit and the second portable communication unit.

15. The communication system of claim 11, wherein the memory stores audio indefinitely until a subsequent audio stream overwrites the stored audio.

16. The communication system of claim 11, wherein the memory is optimized by sampling and compressing the stored audio stream.

17. A portable communication device, comprising:
a transceiver operating as a dispatch radio; and
a processor coupled to the transceiver, wherein the processor is programmed to:
request a retransmission of a recently transmitted audio stream from a memory in an infrastructure system serving the portable communication device; and
receive the retransmission of the recently transmitted audio stream.

18. The portable communication device of claim 17, wherein the processor is programmed to automatically request the retransmission upon determining a received signal quality level below a predetermined threshold.

19. The portable communication device of claim 17, wherein the processor is programmed to request the retransmission upon a user request.
